(19) United States
(12) Patent Application Publication
(10) Pub. No.: US 2009/0150556 A1
(43) Pub. Date: Jun. 11, 2009

(54) MEMORY TO STORAGE COMMUNICATION FOR HYBRID SYSTEMS

(76) Inventors: Moon J. Kim, Wappingers Falls, NY (US); Rajaram B. Krishnamurthy, Wappingers Falls, NY (US); James R. Moulic, Poughkeepsie, NY (US)

Correspondence Address: HOFFMAN WARNICK LLC, 75 STATE ST, 14TH FLOOR, ALBANY, NY, 12207, US

(21) Appl. No.: 11/951,712

(22) Filed: Dec. 6, 2007

(51) Int. Cl. G06F 15/16

(52) U.S. Cl. 709/231

(57) ABSTRACT

Under the present invention, a hybrid system having multiple computing devices and storage devices is provided. The “multiple computing devices” typically include at least one server and at least one processor, both of which include local memory. Thus, the hybrid system will typically have at least two different types of computing devices. The “multiple storage devices” are typically implemented within a storage area network, and include at least one staging storage device and at least one processed data storage device. These devices will be utilized to store incoming data streams in the event that either computing device lacks sufficient space and/or sufficient credits for transmission to another computing device.

### CROSS-REFERENCE TO RELATED APPLICATIONS

This application is related in some aspects to commonly owned and co-pending patent application number (to be provided), entitled “MEMORY TO MEMORY COMMUNICATION AND STORAGE FOR HYBRID SYSTEMS”, assigned attorney docket number END920070479US1, filed concurrently herewith, the entire contents of which are herein incorporated by reference. This application is related in some aspects to commonly owned and co-pending patent application Ser. No. 11/940,506, entitled “SERVER-PROCESSOR HYBRID SYSTEM FOR PROCESSING DATA”, assigned attorney docket number END920070375US1, filed Nov. 15, 2007, the entire contents of which are herein incorporated by reference. This application is related in some aspects to commonly owned and co-pending patent application Ser. No. 11/940,470, entitled “PROCESSOR-SERVER HYBRID SYSTEM FOR PROCESSING DATA”, assigned attorney docket number END920070376US1, filed Nov. 15, 2007, the entire contents of which are herein incorporated by reference.

### FIELD OF THE INVENTION

The present invention generally relates to data communication and storage. Specifically, the present invention relates to a memory to memory data communication and storage within a hybrid system.

### BACKGROUND OF THE INVENTION

Web 1.0 is historically referred to as the World Wide Web, which was originally about connecting computers and making technology more efficient for computers. Web 2.0/3.0 is considered to encompass the communities and social networks that build contextual relationships and facilitates and knowledge sharing and virtual web servicing. Traditional web service can be thought of as a very thin client. That is, a browser displays images relayed by a server, and every significant user action is communicated to the front-end server for processing. Web 2.0 is a social interaction that is consisted of the software layer on the client, so the user gets quick system response. The back-end storage and retrieval of data is conducted asynchronously in the background, so the user doesn't have to wait for the network. Web 3.0 is geared towards the 3 dimensional vision such as in virtual universes. This could open up new ways to connect and collaborate using 3D shared environments. Along these lines, web 3.0 describes the evolution of Web usage and interaction along several separate paths. These include transforming the Web into a database and a move towards making content accessible by multiple non-browser applications. Prior to the inception of the above incorporated patent applications, no approach provided a system that efficiently accommodated web 3.0.

### SUMMARY OF THE INVENTION

The present invention leverages the server-cell and cell-server based hybrid systems incorporated above to provide an approach for memory to storage of data in hybrid systems. Specifically, under the present invention, a hybrid system having multiple computing devices and storage devices is provided. The “multiple computing devices” typically include at least one server (a system z server) and at least one processor (such as that in a cell blade or the like), both of which include local memory (system z, cell, cell blade, and related terms are trademarks of IBM Corp. in the United States and/or other countries). Thus, the hybrid system will typically have at least two different types of computing devices. The “multiple storage devices” are typically implemented within a storage area network, and include at least one staging storage device and at least one processed data storage device. These devices will be utilized to store incoming data streams in the event that either computing device lacks sufficient space and/or sufficient credits for transmission to another computing device.

When a data stream is received by either type of computing device, the receiving computing device will first determine if the data stream or any portion thereof can be stored in its local memory. This determination is made based on a per stream limit and a total storage limit of the receiving computing device. If any portion of the data stream cannot be so stored, the data stream or any portion thereof (such as the portion that cannot be stored locally), can be communicated for (e.g., temporary) storage in one of the storage devices. This is also the case in the event that sufficient credits do not exist for transmitting the data stream or any portion thereof to another computing device in the hybrid system. When the data stream is later needed, it can be retrieved directly from storage by the intended computing device, or it can be retrieved by the computing device that caused its' storage, and then communicated to the intended computing device. In the case of the former, the computing device that caused the storage of the data stream will communicate the identity of the block(s) where the data stream is stored to the intended computing device, which can then directly retrieve the data stream from those blocks.

A first aspect of the present invention provides, a hybrid system for enabling memory to storage communication, comprising: a first computing device having local memory; a second computing device having local memory, the first computing device and the second computing device being configured to send and receive data streams and control signals; a first storage device for receiving a data stream from the first computing device based on a per stream limit and a total storage capacity of the first computing device, and a per stream limit and a total storage capacity of the first storage device; and a second storage device for receiving a data stream from the second computing device based on a per stream limit and a total storage capacity of the second computing device, and a per stream limit and a total storage capacity of the second storage device.

A second aspect of the present invention provides, a method for memory to storage communication for hybrid systems, comprising: receiving a data stream on a first computing device of a hybrid system; attempting to store the data stream on the first computing device up to a per stream limit and a total storage limit of the first computing device; determining whether to store at least a portion of the data stream on a first storage device of the hybrid system that is in communication with the first computing device, the determining being based on the per stream limit and the total storage limit of the first computing device as well as a per stream limit and a total storage limit of the first storage device; communicating the at least a portion of the data stream and a control signal to the first storage device to cause storage of the at least a portion on the second computing device; and communicating a control signal from the first computing device to a second computing device of the hybrid system, the control signal alerting the second computing device that the at last a portion of the data stream is stored on the first storage device.

A third aspect of the present invention provides, a program product stored on a computer readable medium for a method for memory to storage communication for hybrid systems, the computer readable medium comprising program code for causing a computer system to: receive a data stream on a first computing device of a hybrid system; attempt to store the data stream on the first computing device up to a per stream limit and a total storage limit of the first computing device; determine whether to store at least a portion of the data stream on a first storage device of the hybrid system that is in communication with the first computing device, the determining being based on the per stream limit and the total storage limit of the first computing device as well as a per stream limit and a total storage limit of the first storage device; communicate the at least a portion of the data stream and a control signal to the first storage device to cause storage of the at least a portion on the second computing device; and communicate a control signal from the first computing device to a second computing device of the hybrid system, the control signal alerting the second computing device that the at last a portion of the data stream is stored on the first storage device.

A fourth aspect of the present invention provides, a method for deploying a system for memory to storage communication for hybrid systems, comprising: providing a computer infrastructure being operable to: receive a data stream on a first computing device of a hybrid system; attempt to store the data stream on the first computing device up to a per stream limit and a total storage limit of the first computing device; determine whether to store at least a portion of the data stream on a first storage device of the hybrid system that is in communication with the first computing device, the determining being based on the per stream limit and the total storage limit of the first computing device as well as a per stream limit and a total storage limit of the first storage device; communicate the at least a portion of the data stream and a control signal to the first storage device to cause storage of the at least a portion on the second computing device; and communicate a control signal from the first computing device to a second computing device of the hybrid system, the control signal alerting the second computing device that the at last a portion of the data stream is stored on the first storage device.

A fifth aspect of the present invention provides a data processing system for memory to storage communication for hybrid systems, comprising: a memory medium having instructions; a bus coupled to the memory medium; and processing unit coupled to the bus that when executing the instructions causes the data processing system to: receive a data stream on a first computing device of a hybrid system; attempt to store the data stream on the first computing device up to a per stream limit and a total storage limit of the first computing device; determine whether to store at least a portion of the data stream on a first storage device of the hybrid system that is in communication with the first computing device, the determining being based on the per stream limit and the total storage limit of the first computing device as well as a per stream limit and a total storage limit of the first storage device; communicate the at least a portion of the data stream and a control signal to the first storage device to cause storage of the at least a portion on the second computing device; and communicate a control signal from the first computing device to a second computing device of the hybrid system, the control signal alerting the second computing device that the at last a portion of the data stream is stored on the first storage device.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a hybrid system according to one embodiment of the present invention.

FIG. 2 depicts communication between two components of the hybrid system of FIG. 1 according to one embodiment of the present invention.

FIG. 3 depicts communication between two components of the hybrid system of FIG. 1 according to another embodiment according to the present invention.

FIG. 4 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As indicated above the present invention leverages the server-cell and cell-server based hybrid systems incorporated above to provide an approach for memory to storage of data in hybrid systems. Specifically, under the present invention, a hybrid system having multiple computing devices and storage devices is provided. The “multiple computing devices” typically include at least one server (a system z server) and at least one processor (such as that in a cell blade or the like), both of which include local memory (system z, cell, cell blade, and related terms are trademarks of IBM Corp. in the United States and/or other countries). Thus, the hybrid system will typically have at least two different types of computing devices. The “multiple storage devices” are typically implemented within a storage area network, and include at least one staging storage device and at least one processed data storage device. These devices will be utilized to store incoming data streams in the event that either computing device lacks sufficient space and/or sufficient flow-control credits for transmission to another computing device.

When a data stream is received by either type of computing device, the receiving computing device will first determine if the data stream or any portion thereof can be stored in its local memory. This determination is made based on a per stream limit and a total storage limit of the receiving computing device. If any portion of the data stream cannot be so stored, the data stream or any portion thereof (such as the portion that cannot be stored locally), can be communicated for (e.g., temporary) storage in one of the storage devices. This is also the case in the event that sufficient flow-control credits do not exist for transmitting the data stream or any portion thereof to another computing device in the hybrid system. When the data stream is later needed, it can be retrieved directly from storage by the intended computing device, or it can be retrieved by the computing device that caused its' storage, and then communicated to the intended computing device. In the case of the former, the computing device that caused the storage of the data stream will communicate the identity of the block(s) where the data stream is stored to the intended computing device, which can then directly retrieve the data stream from those blocks.

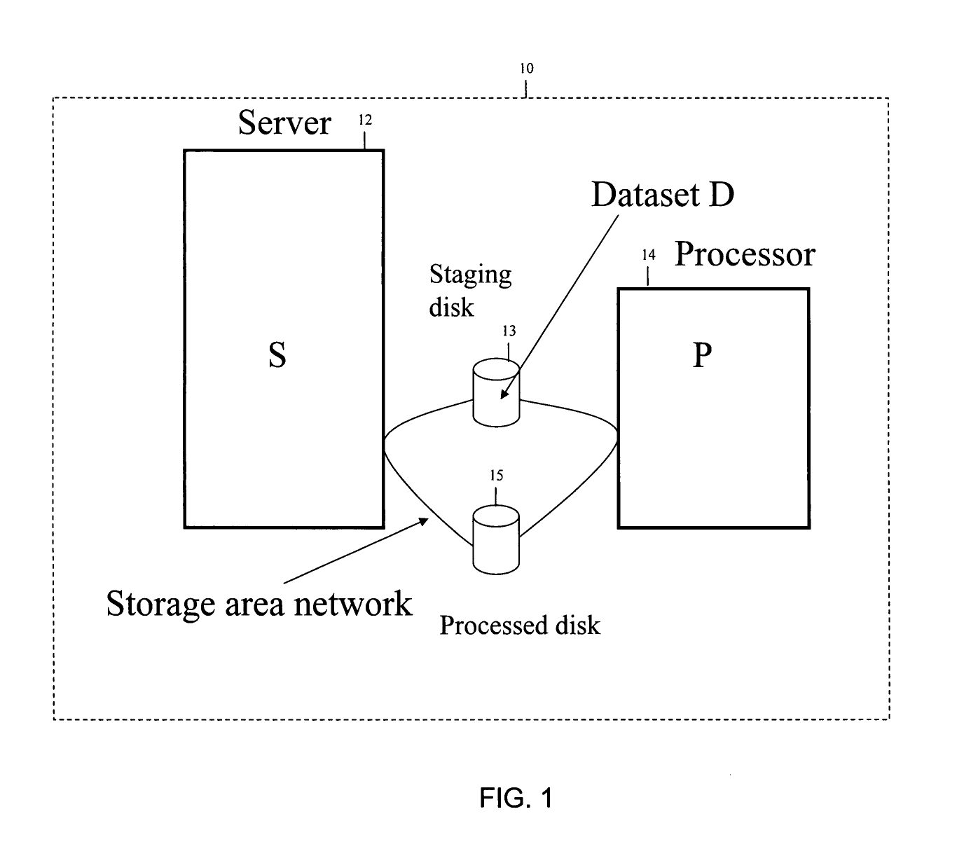

Referring now to FIG. 1, a hybrid system 10 according to the present invention is shown in detail. As depicted, hybrid system 10 includes a server 12 (also referred herein to as “S”), a processor 14 (also referred to herein as “P”), a staging storage device 13, and a processed data storage device 15. It is understood that processor 14 is likely incorporated within computer or the like). As indicated above, when a data stream is received by either server 12 or processor 14, there are multiple events that could lead to the data stream being stored in a storage device 13: (1) if the data stream exceeds either computing device's per stream limit; (2) if the data stream exceeds either computing device's total storage limit for its' local memory; and/or or (3) if insufficient credits exist for the receiving computing device to communicate the data stream or any portion thereof to another “intended” computing device.

If any of these events occur, the receiving computing device will communicate the entire stream, or at least the portion that does not fit in its' local memory to one of storage devices 13 or 15. If server 12 is the initial recipient of the data stream, server 12 outputs to staging storage device 13, while processor outputs to processed data storage device 15. This could be reversed if the data stream is initially received by processor 14. It should be understood that the data stream can originate from many possible locations in accordance with the present invention. For example the data stream may be received at either computing device from private tertiary storage (e.g., disk(s)) of the first computing device, the second computing device etc. Moreover, such private tertiary storage(s) can be used to supplement stream store for received streams at either computing device.

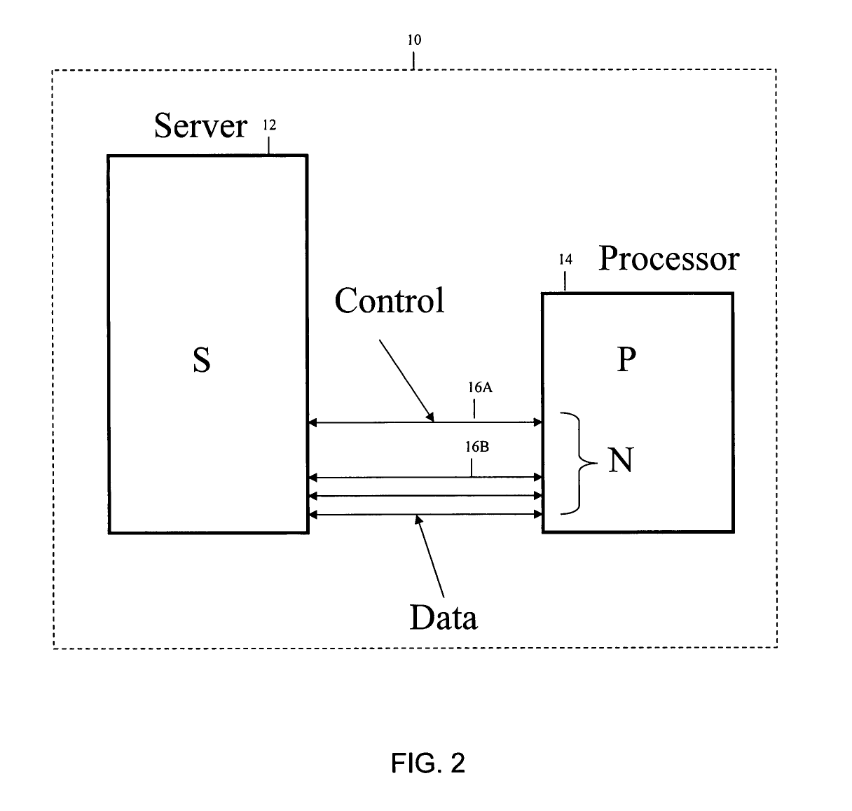

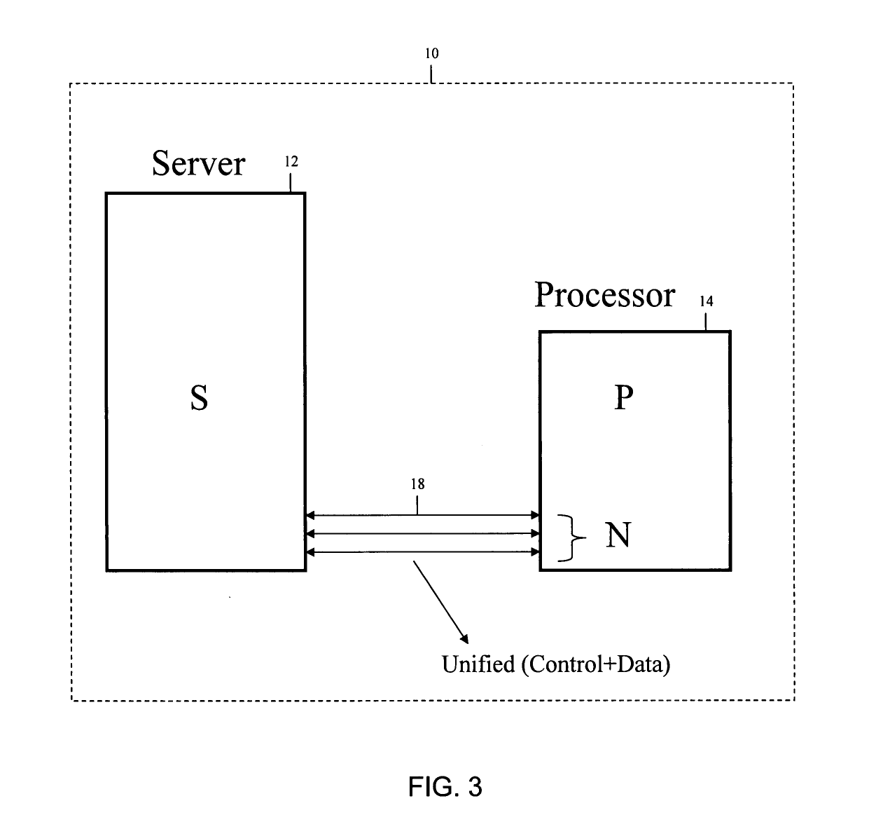

Regardless, as indicated in the above-incorporated patent application filed concurrently herewith, regardless of the use of storage devices 13 and 15, communication can still occur between server 12 and processor 14. Such communication will (at the very least) include a control signal that informs the other of the use of a storage device to store and/or buffer data. As will be further explained below, the communication can also include the data stream itself, or the location of the data stream in a storage device (i.e., the identity of the block(s) where the data stream is stored). In holding such communications, two types of communication occur, a control signal providing instructions for storage of the data, and the data stream itself. As shown in FIG. 2, multiple separate control signals 16A-B can be communicated between server 12 and processor 14. Here two separate connection IDs are needed. However, this need not be the case. For example, referring to FIG. 3, a unified signal is provided. Thus, FIGS. 2 and 3 show that any number of signals could be accommodated within the scope of the present invention. The determination of whether a unified data path (shown in FIG. 3) or separate data paths can be made at set up time (FIG. 2).

Regardless, as mentioned above, when data is stored in a storage device, it can later be received by an intended computerized device. This can occur in multiple different ways. In one embodiment, the computing device that stored the data stream will retrieve the data stream using a pull technique and communicate the same to an intended computerized device (e.g., via push or pull) once sufficient credits for the communication exist. In another embodiment, the computerized device that stored the data stream can communicate the identify of the blocks in the storage device where the data stream was stored to the intended computing devices (e.g., via push or pull), which can then retrieve the data stream using a pull technique. These concepts will be further drawn out below. To first summarize
Data can arrive from either end—S or P
Choice of split control and data path or unified control or data path is made during system setup time (depending on workloads to be handled by system)
S and P can communicate using Push or Pull
Choice of push or pull Is made dynamically during communication time using model selection algorithm
System dynamically selects between “memory to memory” and “memory to/fro storage”. This is done when S or P sends flow-control PAUSE messages to P or S. Alternatively, P or S can run out of flow-control credits for transmission. If flow control messages are received from P then S will write frames directly to staging storage device 13. When P is ready to accept messages, then P will read data from staging storage device 13. When complete, it can signal S and then take data directly from S using memory to memory communication. P can also choose to read data from staging storage device 13 written by S for the lifetime of the stream using pre-arrangement. This bypasses the dynamic selection method.
   Using storage device 13 and 15 attached to a storage area network
Why is this helpful—sometimes coprocessor/accelerator P cannot handle bulk/volume traffic from S. In such instances storage devices 13 and 15 can be used as buffering areas. Sometimes S or P might need historical data from processed data storage device 15 for computation. It will be understood that storage devices 13 and 15 are on the storage area network and can be shared between P and S. Also P and S may also have their own private storage devices that are not accessible by an external system.
Place computing devices 12 and 14 and storage devices 13 and 15 on a storage area network
Data network and control network is still required

In FIG. 1, S and P share access to staging storage device 13 and processed data storage device 15. Storage devices 13 and 15 are disk systems with attached disk controllers. Similar to FIGS. 2 and 3, communication between all components of hybrid system 10 can happen across split or unified control and data paths. If S needs to transfer a data stream “D” to P then the following steps will happen—(i) S must read D and (ii) transfer D to P. This requires a storage to memory copy and a memory to memory copy over the data network. Instead, S can inform P of the name of the dataset and P can read this dataset directly from staging storage device 13. This possible because S and P share staging storage device 13 over the storage network. The steps required for this are listed as follows—

Step 1—S provides dataset name & location (dataset descriptor) along control path to P. This serves as “shoulder tap”. P receives this information by polling for data, “pushed” from S. This can be implemented using “push” or “pull”

Step 2—P reads data from staging storage device 13 using dataset descriptor for D. This can be implemented using “push” or “pull”, the steps of which are shown below:

Step 1 (push form)—“Control Path”
S shoulder taps (writes to) P with dataset name & location (if known).

### Or

Step 1 (pull form)—“Control Path”
S shoulder taps P with data block size (if known) and starting address of data block
P pulls data from S memory.

Step 2 (Pull form)—“Data path”
Staging storage device 13 stores table with dataset name and dataset block locations.
P makes read request to staging storage device 13 with dataset name D.
Staging storage device 13 provides list of blocks with location.
P reads blocks from staging storage device 13.
P encounters end of dataset.
P closes connection.

Step 2 (push form)—“Data Path”
Staging storage device 13 stores table with dataset name and dataset block locations.
P makes “push” request to staging storage device 13 with dataset name D and receiving address location @P on P
Storage controller of staging storage device 13 pushes disk blocks of D directly into memory of P using @C.
Staging storage device 13 closes connection.
   Using processed data storage device 15:

Let us assume that streams arrive from an external source to P. P is sending data to S. S processes data and writes it to disk system processed data storage device 15. It is possible that S needs other data sets from processed data storage device 15 that are from a different set of transactions called historical transactions. It is also possible that S needs data from the current transaction type but from an earlier time from processed data storage device 15. In this case, S can concurrently read data from processed data storage device 15 along with writing processed data to processed data storage device 15.

### Using Staging Disk G:

As data arrives from the external world to S or P, S or P can also use staging storage device 13 as a data staging device. Data from S or P can be buffered on staging storage device 13 until all data is processed or communicated.

### II. Computerized Implementation

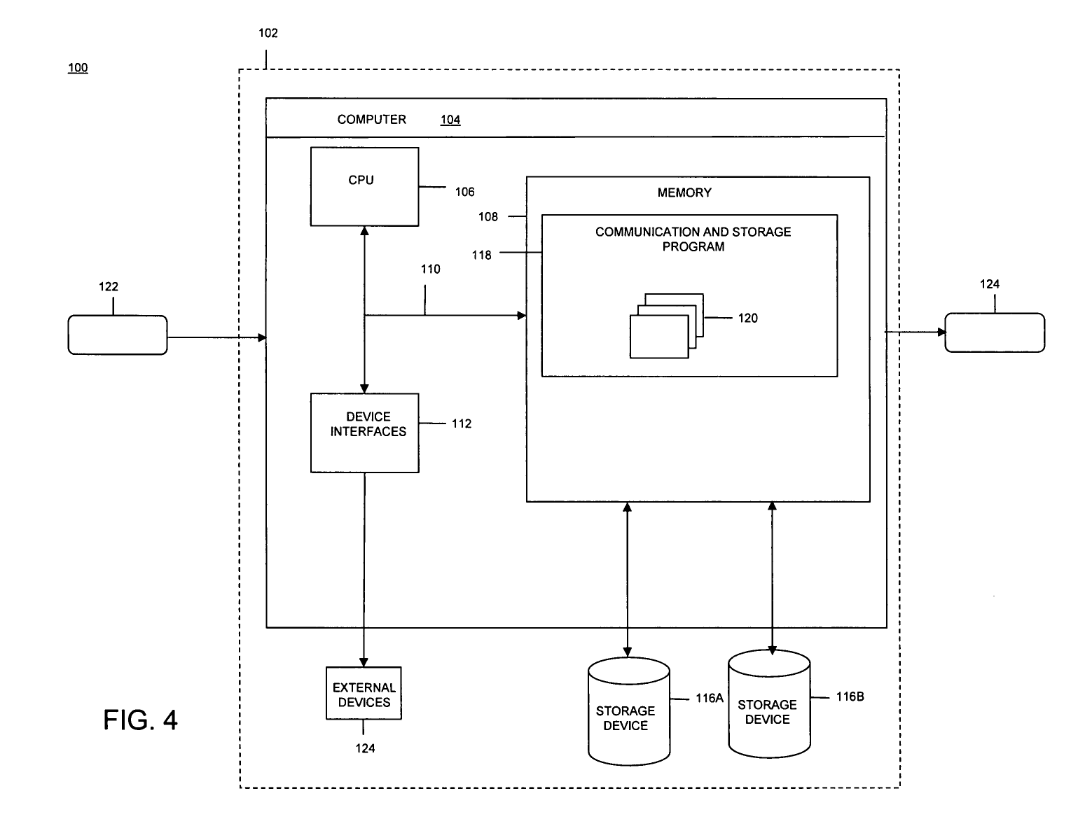

Referring now to FIG. 4, a computerized implementation 100 of the present invention is shown. As depicted, implementation 100 includes computing device 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others. It should be understood that computing device is intended to represents any device of hybrid system 10 (FIGS. 1-2). That is, computing device 104 can be a server or a processor. In addition, although not shown, it should be understood the hybrid system will include multiple computing devices.

As shown, computing device 104 includes a processing unit 106, a memory 108, a bus 110, and device interfaces 112. Further, computing device 104 is shown having image capture device 22 and storage system 116 that communicate with bus via device interfaces (although image capture device 22 alternatively could directly communicate with bus 110). In general, processing unit 106 executes computer program code, such as checkout software/program 24, which is stored in memory 108 and/or storage system 116. While executing computer program code, processing unit 106 can read and/or write data to/from memory 108, storage system 116, and/or device interfaces 112. Bus 110 provides a communication link between each of the components in computing device 104. Although not shown, computing device 104 could also include I/O interfaces that communicate with: one or more external devices such as a kiosk, a checkout station, a keyboard, a pointing device, a display, etc.); one or more devices that enable a user to interact with computing device 104; and/or any devices (e.g., network card, modem, etc.) that enable computing device 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computing device 104 is only representative of various possible computer systems that can include numerous combinations of hardware. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 4 can be included in computing device 104.

Shown in memory 108 of computing device 104 is communication and storage program 118, which a set of modules 120. The modules generally provide the functions of the present invention as described herein. Specifically (among other things), set of modules 120 is configured to: receive a data stream 122 on a first computing device of a hybrid system; attempt to store the data stream on the first computing device up to a per stream limit and a total storage limit of the first computing device; determine whether to store at least a portion 124 of data stream 122 on a first storage device of the hybrid system that is in communication with the first computing device, the determining being based on the per stream limit and the total storage limit of the first computing device as well as a per stream limit and a total storage limit of the first storage device 116A; communicate the at least a portion of the data stream and a control signal to the first storage device 116A to cause storage of the at least a portion on the second computing device; communicate a control signal from the first computing device to a second computing device of the hybrid system, the control signal alerting the second computing device that the at last a portion of the data stream is stored on the first storage device; determine when sufficient flow-control credits for transmitting the data stream from the first computing device to the second computing device exist; read the at least a portion of the data stream from the first storage device 116A when sufficient credits exist; communicate the data stream from the first computing device to the second computing device; communicate a location of blocks in the first storage device that contain the at least a portion of the data stream to the second computing device; and/or read the at least a portion of the data stream directly from the blocks.

It will be understood that each computing device may use private storage (not shown), considered as part of the local memory hierarchy of a computer system to store data. The OS (Operating System) will automatically store data from solid-state memory 108 when 108 reaches memory capacity using virtual memory management algorithms. Set of modules 120 can also be configured to: analyze the volume of data streams and make decisions with respect to communication and storage of data in light of capacity and per stream limits a computing device might have, register discrepancies where item lists cannot be verified by their appearance and/or weight, communicate notifications, arrange payment for verified items, etc.

While shown and described herein as memory to storage communication, it is understood that the invention further provides various alternative embodiments. For example, in one embodiment, the invention provides a computer-readable/useable medium that includes computer program code to enable a computer infrastructure to provide memory to storage communication. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide memory to storage communication. In this case, the service provider can create, maintain, support, etc., a computer infrastructure, such as computer infrastructure 102 (FIG. 4) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for memory to storage communication. In this case, a computer infrastructure, such as computer infrastructure 102 (FIG. 4), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computing device 104 (FIG. 4), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A hybrid system for enabling memory to storage communication, comprising:
a first computing device having local memory;
a second computing device having local memory, the first computing device and the second computing device being configured to send and receive data streams and control signals;
a first storage device for receiving a data stream from the first computing device based on a per stream limit and a total storage capacity of the first computing device, and a per stream limit and a total storage capacity of the first storage device; and
a second storage device for receiving a data stream from the second computing device based on a per stream limit and a total storage capacity of the second computing device, and a per stream limit and a total storage capacity of the second storage device.

2. The hybrid system of claim 1, the hybrid system comprising a storage area network.

3. The hybrid system of claim 1, the first computing device comprising a server.

4. The hybrid system of claim 1, the second computing device comprising a processor.

5. The hybrid system of claim 1, the first storage device being a staging storage device.

6. The hybrid system of claim 1, the second storage device being a processed data storage device.

7. The hybrid system of claim 1, communications between the first computing device and the second computing device occurring via a unified communications signal.

8. The hybrid system of claim 1, communications between the first computing device and the second computing device occurring via a multiple separate communications signals.

9. A method for memory to storage communication for hybrid systems, comprising:
receiving a data stream on a first computing device of a hybrid system;
attempting to store the data stream on the first computing device up to a per stream limit and a total storage limit of the first computing device;
determining whether to store at least a portion of the data stream on a first storage device of the hybrid system that is in communication with the first computing device, the determining being based on the per stream limit and the total storage limit of the first computing device as well as a per stream limit and a total storage limit of the first storage device;
communicating the at least a portion of the data stream and a control signal to the first storage device to cause storage of the at least a portion on the second computing device; and
communicating a control signal from the first computing device to a second computing device of the hybrid system, the control signal alerting the second computing device that the at last a portion of the data stream is stored on the first storage device.

10. The method of claim 9, the determining further based on an availability of sufficient flow-control credits for transmitting the data stream from the first computing device to the second computing device.

11. The method of claim 10, further comprising:
having the sufficient flow-control credits for transmitting the data stream from the first computing device to the second computing device;
reading the at least a portion of the data stream from the first storage device; and
communicating the data stream from the first computing device to the second computing device.

12. The method of claim 9, further comprising
having the sufficient flow-control credits for transmitting the data stream from the first computing device to the second computing device;
communicating a location of blocks in the first storage device that contain the at least a portion of the data stream to the second computing device; and
the second computing device reading the at least a portion of the data stream directly from the blocks.

13. A program product stored on a computer readable medium for memory to storage communication for hybrid systems, the computer readable medium comprising program code for causing a computer system to:
receive a data stream on a first computing device of a hybrid system;
attempt to store the data stream on the first computing device up to a per stream limit and a total storage limit of the first computing device;
determine whether to store at least a portion of the data stream on a first storage device of the hybrid system that is in communication with the first computing device, the determining being based on the per stream limit and the total storage limit of the first computing device as well as a per stream limit and a total storage limit of the first storage device;
communicate the at least a portion of the data stream and a control signal to the first storage device to cause storage of the at least a portion on the second computing device; and
communicate a control signal from the first computing device to a second computing device of the hybrid system, the control signal alerting the second computing device that the at last a portion of the data stream is stored on the first storage device.

14. The program product of claim 13, the computer readable medium further comprising program code for causing the computer system to determine whether to store at least a portion of the data stream on there first storage device further based on an availability of sufficient credits for transmitting the data stream from the first computing device to the second computing device.

15. The program product of claim 14, the computer readable medium further comprising program code for causing the computer system to:
determine when sufficient credits for transmitting the data stream from the first computing device to the second computing device exist;
read the at least a portion of the data stream from the first storage device when the sufficient credits exits; and
communicate the data stream from the first computing device to the second computing device.

16. The program product of claim 14, the computer readable medium further comprising program code for causing the computer system to:
determine when sufficient credits for transmitting the data stream from the first computing device to the second computing device exist;
communicate a location of blocks in the first storage device that contain the at least a portion of the data stream to the second computing device; and
read the at least a portion of the data stream directly from the blocks.

17. A method for deploying a system for memory to storage communication for hybrid systems, comprising:
providing a computer infrastructure being operable to:
receive a data stream on a first computing device of a hybrid system;
attempt to store the data stream on the first computing device up to a per stream limit and a total storage limit of the first computing device;
determine whether to store at least a portion of the data stream on a first storage device of the hybrid system that is in communication with the first computing device, the determining being based on the per stream limit and the total storage limit of the first computing device as well as a per stream limit and a total storage limit of the first storage device;
communicate the at least a portion of the data stream and a control signal to the first storage device to cause storage of the at least a portion on the second computing device; and
communicate a control signal from the first computing device to a second computing device of the hybrid system, the control signal alerting the second computing device that the at last a portion of the data stream is stored on the first storage device.

18. The method of claim 9, the computer infrastructure being further operable to:
determine whether to store at least a portion of the data stream on the first storage device further based on an availability of sufficient credits for transmitting the data stream from the first computing device to the second computing device.

19. The method of claim 9, the computer infrastructure being further operable to:
determine when sufficient credits for transmitting the data stream from the first computing device to the second computing device;
read the at least a portion of the data stream from the first storage device; and
communicate the data stream from the first computing device to the second computing device.

20. The method of claim 9, the computer infrastructure being further operable to:
determine when sufficient credits for transmitting the data stream from the first computing device to the second computing device;
communicate a location of blocks in the first storage device that contain the at least a portion of the data stream to the second computing device; and
read the at least a portion of the data stream directly from the blocks.
